(19) United States
(12) Patent Application Publication
(10) Pub. No.: US 2012/0105019 A1
(43) Pub. Date: May 3, 2012

(54) GENERATOR REGULATING SYSTEM HAVING MAIN AND AUXILIARY REGULATORS

(76) Inventors: Helmut SUELZLE, Freiberg (DE); Walter Kohl, Cleebronn (DE); Kai-Oliver Homeyer, Ludwigsburg (DE); Ralf Herbig, Stuttgart (DE)

(21) Appl. No.: 13/295,901

(22) Filed: Nov. 14, 2011

Related U.S. Application Data
(63) Continuation of application No. 10/848,226, filed on May 17, 2004, now abandoned.

(30) Foreign Application Priority Data
May 15, 2003 (DE) 103 21 872.6

(51) Int. Cl. H02P 9/48

(52) U.S. Cl. 322/23

(57) ABSTRACT

A regulating device for regulating the output voltage of a generator; in particular a vehicle generator is described. To improve protection of the voltage regulation from failure, for normal operation it is proposed to perform the regulation using a main regulator which is implemented as software in a control unit, and in the event of a malfunction of the main regulator, to perform the regulation using an auxiliary regulator.

### FIELD OF THE INVENTION

The present invention relates to a regulating device for regulating the output voltage of a generator, in particular a vehicle generator, and to a corresponding regulating method.

### BACKGROUND INFORMATION To generate a system voltage of 14 V, for example, externally excited synchronous machines are typically used in motor vehicles. The generators include a regulator which adjusts the output voltage of the generator to an optimum charging voltage for the vehicle battery. As a rule, the generator regulator is structurally integrated along with the generator into a generator unit. In another embodiment, the externally mounted regulator, the voltage regulator, is situated in a control unit externally to the generator. The various designs of a regulating system for a vehicle generator, which are known from the related art, are explained in greater detail below, with reference to FIGS. 1 through 3.

FIG. 1 shows a generator regulation system having an internal voltage regulator 1; i.e., voltage regulator 1 is integrated into a structural generator unit 8. The hardware of voltage regulator 1 is implemented as an electronic circuit.

Generator unit 8 includes, for example, a three-phase or six-phase generator 2, a rectifier 3 for rectifying phase voltages U, V, W of generator 2, voltage regulator 1, and a power output stage 11 which is controlled by voltage regulator 1 and through which an intended excitation current is established in excitation coil L.

Power output stage 11 includes a switching transistor through which excitation current Ierr flows. Excitation current Ierr is adjusted by switching the transistor on and off using a predetermined pulse duty factor in such a way that the intended phase voltage results across generator 2 as a function of the rotational speed and load on the generator.

The regulating system also includes a control unit 4 which makes it possible for specific regulating instructions to be transmitted to regulator 1. To this end, control unit 4 is connected to regulator 1 via a digital interface 6. A setpoint value for generator output voltage Uₒᵤₜ or, for example, the maximum allowable slope of the change in the manipulated variable (DF signal) output by regulator 1 may be specified by control unit 4.

Diagnostic data, for example, or other information such as the type of generator or regulator, the instantaneous pulse duty factor, or information about the generator state such as for example generator temperature, excitation current, error information, etc. may be transmitted in the opposite direction, i.e., from regulator 1 to control unit 4, via digital interface 6.

Control unit 4 may be a control unit for managing electrical power and load which also includes battery state detection for determining predetermined battery parameters such as for example the state of charge (SOC) or the state of health (SOH) of the battery. Connected to control unit 4 is an engine controller 5 which transmits instantaneous data about the state of the engine, such as the rotational speed or engine temperature, for example, to control unit 4 for determining the engine torque.

Using this data, it is possible to take into account in particular the torque available from the engine in the calculation of the setpoint voltage to prevent generator 2 from causing the engine to stall. For low rotational speeds and low engine power output, the load on the internal combustion engine is kept low by generator 2, and only a slow increase in the excitation current Ierr is allowed (also referred to as load response function). In the meantime, the battery must supply the onboard electrical system with energy until the generator again delivers sufficient power.

The regulating system illustrated in FIG. 1 having a regulator 1 situated in generator unit 8 has the advantage that it continues to function even when control unit 4 malfunctions or digital interface 6 is disconnected. In this case, regulator 1 regulates generator output voltage Uout to a standard value or the last obtained setpoint value, for example. A significant disadvantage of this system, however, is that the electronics are installed directly on the generator, and integrated regulator 1 and power output stage 11 must be protected or encased in a very complex (i.e., costly) manner because of the high thermal and mechanical stresses on generator 2.

For this reason, it is becoming increasingly common to implement regulating systems in which sensitive (electronic) modules are situated outside generator unit 8. Such a known system is illustrated in FIG. 2.

FIG. 2 shows a regulating system having an external voltage regulator 1 for which power output stage 11 is also structurally integrated into generator unit 8.

Voltage regulator 1 in this case is implemented as software and is housed in an external control unit 4. The actual regulation, specifically, the setpoint/actual value comparison and calculation of the manipulated variable, is performed by the software.

The manipulated variable, in the present case a switching signal (DF signal), is transmitted via an interface 10 to switching transistor 12 for power output stage 11. Power output stage 11 appropriately adjusts excitation current Ierr flowing through excitation coil L. A freewheeling diode D is connected in parallel to the excitation coil. Control unit 4 is also connected via a line 9 to a phase terminal, for example terminal V, of generator 2 to monitor the state of the generator.

This design as well has the disadvantage that the electronics, in particular switching transistor 12, housed in power output stage 11 are mounted directly on generator 2 and are thus exposed to high temperatures and strong vibrations. The significant disadvantage of this system, however, is that when the control unit breaks down or the control line to power output stage 11 is disconnected, the generator control and thus also generator 2 completely fail. It is likewise not possible to transmit diagnostic information from the generator to control unit 4.

FIG. 3 shows a regulating system in which both voltage regulator 1 and power output stage 11 are situated completely external to generator unit 8 and are integrated into control unit 4. Control unit 4 contains the power output stage and is directly connected to excitation coil L via connecting lines, and sends excitation current Iₑᵣᵣ, directly as a manipulated variable. The regulating algorithm is integrated as software into control unit 4. Otherwise, this system has a design essentially identical to that in FIG. 2.

This design as well has the significant disadvantage that when control unit 4 breaks down the entire voltage regulation system and thus also generator 2 fail.

### SUMMARY OF THE INVENTION

An object of the present invention is to increase the availability of electrical power in the onboard electrical system.

The concept of the present invention lies in the fact that a main regulator situated apart from (external to) the generator unit is provided which performs the voltage regulation during normal operation, and in addition an auxiliary regulator is provided, preferably integrated into the generator unit, which takes over the regulation when the main regulator malfunctions or a control line is disconnected, and ensures emergency regulation or at least emergency control. This has the advantage that the generator still produces a predetermined minimum voltage, even when the main regulator completely fails. In addition, the complexity of the circuitry of auxiliary regulator 13 is significantly reduced compared to a conventional integrated voltage regulator, since the auxiliary regulator need only have a very low range of functions.

The main regulator is preferably installed as software in an external control unit. Individual control parameters may thus be adapted very easily to various applications or operating states, and may even be readjusted during operation. The auxiliary regulator is preferably implemented as electronic circuiting in hardware on the generator unit.

Another aspect of the present invention lies in the fact that the availability of electrical power is increased due to the bidirectional coordination between the internal combustion engine and the generator. Hitherto, for an abrupt increase in energy demand the generator has been regulated upward only slowly, corresponding to a load response function, to avoid excessive load on the internal combustion engine, specifically at low rotational speeds.

The external control unit is preferably set up in such a way that it is able to actively influence the engine control or perform other power-increasing measures when there is a particularly high power demand and the stability of the onboard electrical system is endangered. For a high electrical power demand in the onboard electrical system, for example a signal may be transmitted to the engine control which brings the internal combustion engine (in idling mode) to an operating point having higher engine power or higher torque. Optionally, the transmission could also be shifted to a lower gear to bring the engine to higher rotational speeds. At the precise moment of an impending failure of electrically supported systems relevant to safety (brakes, steering, for example) due to a power shortage, it is thus possible to rapidly increase the generator power output without the risk of stalling the engine. Conversely, the generator power may be decreased, for example when the engine state is unstable.

The main regulator according to the present invention is preferably set up so that it is able to receive various sensor and operating state information via digital interfaces, for example, for the purpose of ensuring a stable onboard electrical system with consideration for the generator performance, the state of health of the engine, the electrical consumers in the onboard electrical system, and/or the state of the battery. To this end, the main regulator is preferably connected to at least one control device such as for example the engine control unit and/or sensor mechanisms such as battery state detection system and/or a terminal (B+) in the onboard electrical system.

According to one preferred embodiment of the present invention, the generator unit includes a power output stage having a switching transistor for adjusting the excitation current. In this case, the external main regulator generates control signals for the transistor in the power output stage.

The manipulated variable output to the power output stage from the main regulator may be transmitted via a pulse wide modulation (PWM) or a digital interface, for example. In the case of digital transmission, the digital signal may be converted by a suitable device, which for example is integrated into the auxiliary regulator, into a corresponding control signal for the switching transistor in the power output stage.

According to one preferred embodiment of the present invention, the manipulated variable sent from the main regulator may be checked for plausibility, for example by checking the absolute value or rate of change of the manipulated variable. The regulating function is preferably monitored threshold value. A malfunction of the main regulator or a disconnection of the interface may thus be easily detected when, for example, the absolute value or the rate of change of the manipulated variable exceeds predetermined threshold values.

The external main regulator is preferably connected to an engine controller which preferably transmits instantaneous parameters of the internal combustion engine such as for example the engine rotational speed or engine torque or data for determining same, to the control unit, which is able to take these parameters into account in regulating the generator. Thus, at low engine power and rotational speeds it is possible to prevent stalling of the internal combustion engine via an appropriately slow increase in the generator power. This “gentle” regulation is also referred to as load response (LR) regulation.

The generator unit preferably includes a temperature sensor which measures the generator temperature or a proportional variable. The sensor signal is transmitted to the main regulator and preferably to the auxiliary regulator as well, so that it is possible to downwardly regulate the generator in both normal operation and emergency operation when overheating occurs.

### BRIEF DESCRIPTION OF THE DRAWINGS

FIG. 1 shows a first embodiment of a generator regulating system according to the related art.

FIG. 2 shows a second embodiment of a generator regulating system according to the related art.

FIG. 3 shows a third embodiment of a generator regulating system according to the related art.

FIG. 4 shows a regulating system for regulating a vehicle generator according to a first embodiment of the present invention.

FIG. 5 shows a regulating system for regulating a vehicle generator according to a second embodiment of the present invention.

FIG. 6 shows a flow diagram for illustrating the method steps of a generator regulating system according to the present invention.

FIG. 7 shows a flow diagram for illustrating another aspect of the present invention.

### DETAILED DESCRIPTION

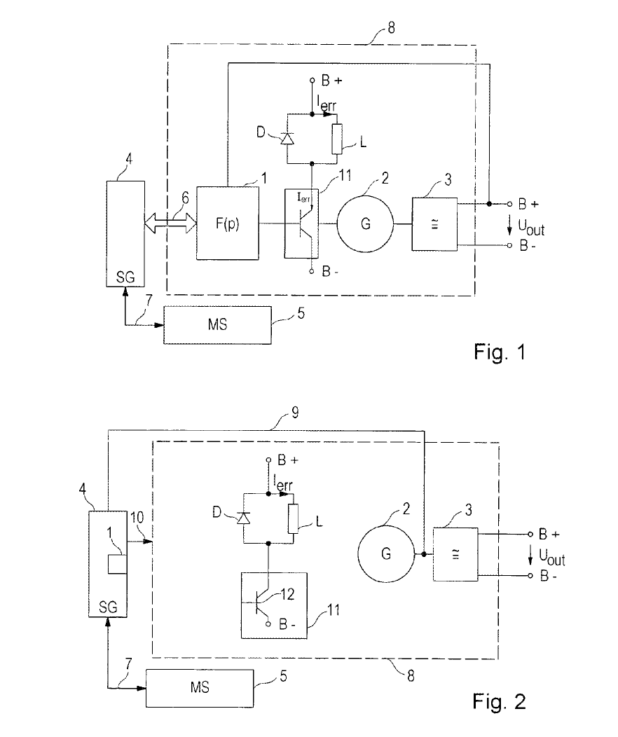

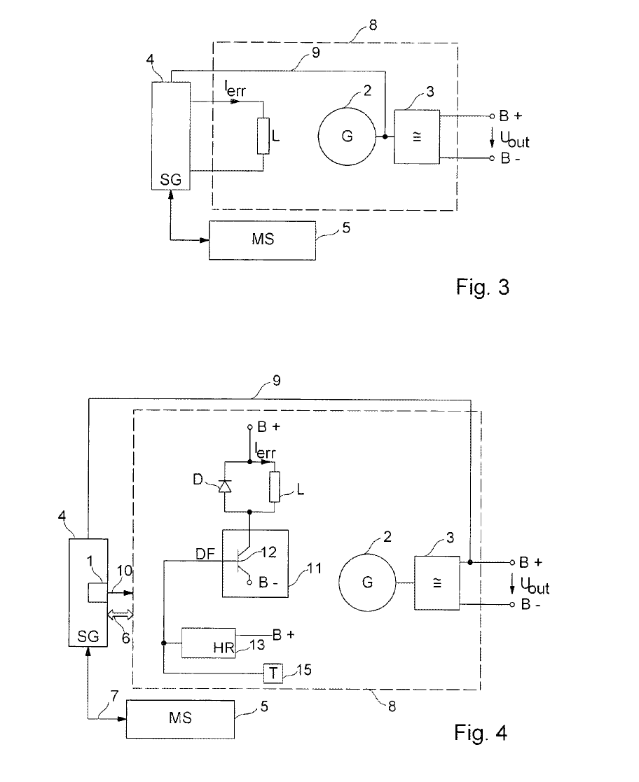

With regard to the explanation of FIGS. 1 through 3, reference is made to the Background Information section.

FIG. 4 shows a regulating system for regulating output voltage Uₒᵤₜ of a vehicle generator 2, using an external voltage regulator 1. The regulating system includes a generator unit 8 in which generator 2 is integrated as a structural unit together with a rectifier 3, a power output stage 11, and an auxiliary regulator 13. The generator unit also contains an excitation coil L and a freewheeling diode D. Power output stage 11 includes a transistor 12 which is controlled by a control unit 4 using a predetermined pulse duty factor.

Main regulator 1 is implemented as software, structurally separated from generator unit 8. Control unit 4 may be a control unit for managing electrical power and consumption, an engine control unit, or a central computer, for example.

In normal operation the generator is regulated by main regulator 1, which generates an appropriate manipulated variable as a function of the instantaneous actual voltage, taking into account the available engine power. The manipulated variable may be supplied to power output stage 11, either via a PWM interface 10 or a digital interface 6. The manipulated variable is converted by auxiliary regulator 13 into a corresponding control signal for switching transistor 12 (optionally, the control signal could also be transmitted directly to transistor 12).

The pulse duty factor (on time/off time) determines the magnitude of excitation current Iₑᵣᵣ flowing through excitation coil L, and thus the magnitude of the phase voltages induced in the stator windings of generator 2. Rectifier 3 is used for rectifying the phase voltages from generator 2, and produces generator output voltage Uₒᵤₜ at its output.

The manipulated variable output by main regulator 1 is checked for plausibility by a suitable device which is integrated into auxiliary regulator 13, for example. One criterion for the plausibility of the manipulated variable may be the rate of change or the absolute value thereof, for example.

As long as the manipulated variable is in a specified range within predetermined limiting values (normal operation), auxiliary regulator 13 does not perform a regulating function. However, if a malfunction or a breakdown of main regulator 1 is detected, auxiliary regulator 13 becomes active and takes over emergency regulation, or at least emergency control, of generator 2. It is thus possible for auxiliary regulator 13 to regulate the regulating variable to a fixed setpoint value, for example, or to use the last plausible control signal obtained or an average value of the control signal, for example, as an auxiliary manipulated variable.

Furthermore, defined data from generator unit 8 may be transmitted to control unit 4 via digital interface 6. Such data may be diagnostic parameters, the instantaneous DF signal, the instantaneous excitation current Iₑᵣᵣ, a generator temperature, or error messages, for example.

The generator system also includes a temperature sensor 15 for measuring the generator temperature or a proportional variable. The generator temperature is preferably transmitted to both main regulator 1 and auxiliary regulator 13. When generator 2 overheats it is thus possible to reduce the excitation of, and thus the load on, the generator.

Main regulator 1 according to the present invention is preferably set up so that it is able to receive various types of sensor information and operating state information via digital interfaces, for example, for the purpose of ensuring a stable onboard electrical system with consideration for the generator state of health, the state of health of the engine, of the electrical consumers in the onboard electrical system, and/or the state of the battery. To this end, the main regulator is preferably connected to engine control unit 5, battery state detector (integrated into control unit 4), and terminal B+ of the onboard electrical system. The supply to the onboard electrical system may be optimized as a function of the information obtained about the state of health of the internal combustion engine (engine torque), the state of the battery, etc., by adapted regulation of generator 8.

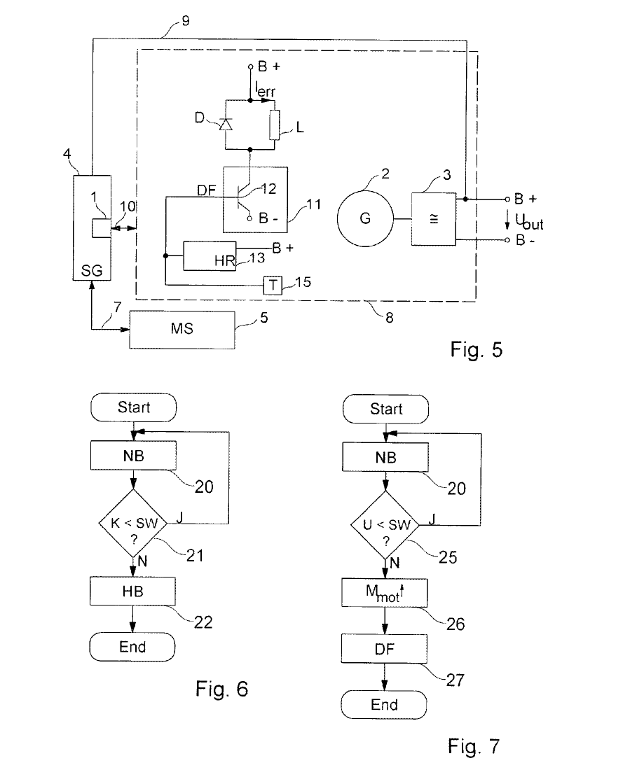

FIG. 5 shows a second embodiment of a regulating system according to the present invention in which, in contrast to FIG. 4, a PWM interface 10 is provided between control unit 4 and generator unit 8. In this embodiment, diagnostic data and other information may be transmitted during an initialization phase from generator unit 8 to control unit 4, before the regulation begins. The regulation then occurs with a time delay in the opposite direction.

FIG. 6 shows the method steps of redundant voltage regulation in the form of a flow diagram. In step 20, normal operation is carried out in which the regulation is performed by main regulator 1. In step 21, manipulated variable K transmitted by main regulator 1 is checked for plausibility by a logic system contained in generator unit 8 which may be integrated into auxiliary regulator 13, for example, a threshold value, for example, being monitored. If manipulated variable K or a function of manipulated variable K, such as a DF signal or the rate of change thereof, for example, is within predetermined threshold values SW (case J), normal operation NB is maintained. When a predetermined threshold value SW (case N) is exceeded, in step 22 auxiliary regulator 13 runs in non-operational mode HB which ensures operation of generator 2, even if main regulator 1 fails.

An additional aspect of the present invention, which results in more rapid availability of electrical power in the onboard electrical system, is illustrated in FIG. 7. In normal operation (step 20) a check is continuously performed as to whether there is sufficient power in the onboard electrical system. This may be achieved by monitoring the system voltage or evaluating start-up requirements of consumers (step 25), for example. When the supply is sufficient (case J), normal operation continues. When there is an undersupply of electrical power or an undersupply is imminent (because of start-up requirements for multiple large consumers, for example), control unit 4 directs engine control 5 to bring the internal combustion engine to an operating point featuring higher engine torque. It is thus possible to increase the excitation (DF signal) of generator 2 much more quickly without overloading the engine.

It is also possible to take into account additional operating information such as the generator temperature, state of the vehicle battery, etc., in the voltage regulation.

List of Reference Numbers

1 Voltage regulator

2 Generator

3 Rectifier

4 Control unit

5 Engine controller

6 Digital interface

7 Interface for engine controller

8 Generator unit

9 Line

10 PWM interface

11 Power output stage

12 Switching transistor

13 Auxiliary regulator

15 Temperature sensor

20-22 Method steps

D Freewheeling diode

L Excitation coil

Uout Output voltage

Ierr Excitation current

1-14. (canceled)

15. A regulating device for regulating an output voltage of a generator situated in a structural generator unit, comprising:
a main regulator situated separately from the structural generator unit and for performing a voltage regulation during normal operation, the main regulator producing a manipulated variable that is transmitted to the structural generator unit;
an auxiliary regulator that takes over one of a generator regulation and a generator control when the main regulator malfunctions, the auxiliary regulator being situated in the structural generator unit; and
a device for checking a manipulated variable supplied by the main regulator for plausibility, in order to detect a malfunction;
wherein the generator includes a vehicle generator, wherein the main regulator is implemented as software in a control unit,
wherein the auxiliary regulator includes an electronic circuit,
wherein the main regulator is connected to an engine controller and takes information on an engine power output into account in the regulation, and
wherein the control unit one of increases an engine power of an internal combustion engine when there is a high electrical power demand, and decreases a generator power when an engine state is unstable.

16. The regulating device of claim 15, wherein the main regulator outputs a switching signal for one of a switching output stage and an excitation current as a manipulated variable.

17. The regulating device of claim 15, further comprising:
a temperature sensor that generates a measured value and transmits the measured value to the main regulator and the auxiliary regulator, the temperature sensor protecting the generator from overheating.

18. The regulating device of claim 15, further comprising:
a temperature sensor that generates a measured value and transmits the measured value to the main regulator and the auxiliary regulator, the temperature sensor protecting the generator from overheating;
wherein the main regulator outputs a switching signal for one of a switching output stage and an excitation current as a manipulated variable.

19. The regulating device of claim 18, wherein one of the main regulator and the auxiliary regulator outputs a control signal for a switching output stage contained in the generator unit as a manipulated variable.

20. The regulating device of claim 18, wherein the main regulator and the auxiliary regulator communicate with one another via a digital interface.

21. The regulating device of claim 20, wherein the control signal is transmitted to the generator unit via an analog interface.

22. The regulating device of claim 18, wherein one of the main regulator and the auxiliary regulator outputs a control signal for a switching output stage contained in the generator unit as a manipulated variable, wherein the main regulator and the auxiliary regulator communicate with one another via a digital interface, and wherein the control signal is transmitted to the generator unit via an analog interface.

23. The regulating device of claim 15, wherein one of the main regulator and the auxiliary regulator outputs a control signal for a switching output stage contained in the generator unit as a manipulated variable.

24. The regulating device of claim 15, wherein the main regulator and the auxiliary regulator communicate with one another via a digital interface.

25. The regulating device of claim 23, wherein the control signal is transmitted to the generator unit via an analog interface.

26. The regulating device of claim 15, wherein one of the main regulator and the auxiliary regulator outputs a control signal for a switching output stage contained in the generator unit as a manipulated variable, wherein the main regulator and the auxiliary regulator communicate with one another via a digital interface, and wherein the control signal is transmitted to the generator unit via an analog interface.

27. A method for regulating an output voltage of a generator situated in a structural generator unit, comprising:
regulating the output voltage of the generator using a main regulator that is situated externally to the generator unit;
one of regulating and controlling the generator output voltage using an auxiliary regulator, when the main regulator malfunctions, the auxiliary regulator being situated in the structural generating unit; and
checking a manipulated variable supplied by the main regulator for plausibility to detect a malfunction;
wherein the generator includes a vehicle generator,
wherein the main regulator is implemented as software in a control unit, p1 wherein the auxiliary regulator includes an electronic circuit,
wherein the main regulator is connected to an engine controller and takes information on an engine power output into account in the regulation, and
wherein the control unit one of increases an engine power of an internal combustion engine when there is a high electrical power demand, and decreases a generator power when an engine state is unstable.

28. The method of claim 27, wherein one of the main regulator and the auxiliary regulator outputs a control signal for a switching output stage contained in the generator unit as a manipulated variable.

29. The method of claim 27, wherein the main regulator and the auxiliary regulator communicate with one another via a digital interface.

30. The method of claim 28, further comprising:
transmitting the control signal to the generator unit via an analog interface.

31. The method of claim 27, wherein one of the main regulator and the auxiliary regulator outputs a control signal for a switching output stage contained in the generator unit as a manipulated variable, and wherein the main regulator and the auxiliary regulator communicate with one another via a digital interface.

32. The method of claim 31, further comprising:
transmitting the control signal to the generator unit via an analog interface.
